(19) United States
(12) Patent Application Publication
(10) Pub. No.: US 2004/0024922 A1
(43) Pub. Date: Feb. 5, 2004

(54) Two-way communications link at sub-operating system level

(76) Inventor: Henry C. Yuen, Pasadena, CA (US)

Correspondence Address: CHRISTIE, PARKER & HALE, LLP, P.O. BOX 7068, PASADENA, CA, 91109-7068, US

(21) Appl. No.: 10/377,398

(22) Filed: Feb. 27, 2003

Related U.S. Application Data
(60) Provisional application No. 60/360,371, filed on Feb. 27, 2002.

(51) Int. Cl. G06F 3/00

(52) U.S. Cl. 710/1

(57) ABSTRACT

A computer includes a processor, a video controller having a video output, a bus connected between the processor and the video controller and a communication device connected to the bus. An operating system, utilizing the processor, directs the operation of the video controller. The computer also includes a communications stack that communicates with a remote computer and with the video controller to control at least of a portion of the video output of the video controller, independent of the operation of the operating system.

### CROSS-REFERENCE TO RELATED APPLICATION

This application claims priority of U.S. Provisional Application No. 60/360,371, filed Feb. 27, 2002, the disclosure of which is incorporated fully herein by reference.

### BACKGROUND OF THE INVENTION

A common way to allow for a variety of hardware to be plugged in to a modern personal computer and still allow proper operation with a standard operating system such as Microsoft Windows involves the use of a ROM driver at the “BIOS” (Basic Input Output System) level. As an example, a specific graphics adapter might require special programming or offer an unusual screen size to the operating system. These characteristics are “abstracted” away by the use of a set of BIOS calls which perform such functions as changing screen resolution. Another example of the use of BIOS routines would be the ability to boot a computer over a network using an ethernet card. In both cases, however, under normal operation of the operating system the major functions (drawing images on a screen or sending packets through the network card) are primarily handled by operating system drivers and screen or network activity is initiated by operating system routines and applications.

Recently the value of personal computer “screen real estate” has become clear to some manufacturers. They would like to offer specific features (possibly with advertisements) to their customers, using the revenues to defray the cost of the PC hardware. Their license agreements with the major operating system vendor, however, do not give them any control of the state of the “boot-up” screen appearance. A company (Pixel Company) has recently demonstrated a system which “hides” some of the screen real estate from the operating system. In other works, if the screen can actually display 680 lines vertically, the BIOS tells the operating system that only 640 lines of pixels are available for display. The bottom 40 lines (in this hypothetical example) are not under control of the operating system. Pixel Company's technology allows a system vendor to sell real estate on that bottom 40 lines to their partners for display of information and ads. This display is done solely by the BIOS routines in ROM without general use of the operating system itself. (As part of this process, the BIOS probably has to tell the OS that it has slightly less RAM than exists in reality to make room for the BIOS program's storage.)

### SUMMARY OF THE INVENTION

In one aspect, the invention is a computer that includes a processor, a video controller having a video output, a bus connected between the processor and the video controller and a communication device connected to the bus. An operating system, utilizing the processor, directs the operation of the video controller. The computer also includes a communications stack that communicates with a remote computer and with the video controller to control at least of a portion of the video output of the video controller, independent of the operation of the operating system.

### BRIEF DESCRIPTION OF THE DRAWINGS

FIG. 1 is a block diagram of a general purpose computer in accordance with one embodiment of the present invention.

### DETAILED DESCRIPTION OF THE INVENTION

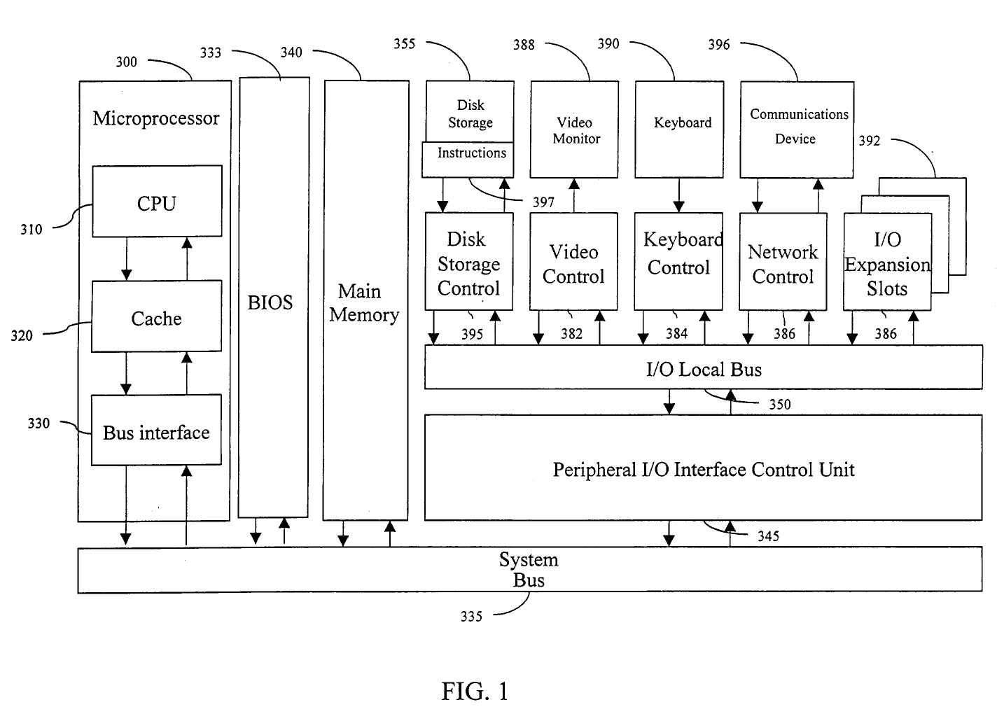

FIG. 1 is a hardware architecture diagram of a general purpose computer. A microprocessor 300, comprising a Central Processing Unit (CPU) 310, a memory cache 320, and a bus interface 330, is operatively coupled via a system bus 335 to a BIOS (Basic Input/Output System) 333, a main memory 340 and a I/O control unit 345. The I/O control unit is operatively coupled via a I/O local bus 350 to a storage controller 395, a video controller 382, a keyboard controller 384, a network controller 380, and an I/O device controller 386.

The storage controller is operatively coupled to a storage device 325. Computer program instructions 397 for implementing a applications are stored on the storage device until the microprocessor retrieves the computer program instructions and stores them in the main memory. The microprocessor then executes the computer program instructions stored in the main memory to implement the features of the application.

The video controller is operably coupled to an electronic display device 388 for display of text and graphics, as controlled by the microprocessor, the operating system and the applications run by the microprocessor. The keyboard controller is operably coupled to a keyboard 390 for input of user commands. The I/O device controller is operably coupled to any specialized input/output device 392.

The network controller is operatively coupled to a communications device 396. The communications device is adapted to allow applications hosted by the general purpose computer to communicate via a computer network such as the Internet with other software objects on the computer network as previously described.

The general purpose computer shown in FIG. 1 may run an operating system such as one of the various “Windows” operating systems licensed by Microsoft Corporation. “Windows” is a trademark of Microsoft Corporation.

In a variation of a computer system in which the BIOS hides some of the screen real estate from the operation system, the computer system communicates with the information/advertising partners through operating system-level calls, using, for example, a Windows TCP/IP stack and an OS-level application which gets loaded and run.

An alternative communications method would be to have a full communications stack also running without OS knowledge. In one embodiment, this communications stack might use standard phone lines. In another approach, the system uses a communication method that is simpler to setup, such as a method that does not require phone numbers and ISP gateway numbers and the like. Such methods includes a wireless two-way system such as a ReFLEX Paging or a wireless modem such as a wireless Mobitex modem built into the PC. Such a system would allow the display of information and graphics in the extra screen real estate without any knowledge of the system by the OS. This communications medium could be made available to the OS for other purposes (such as wireless email) through BIOS calls. This system is relatively operating system-independent; it could display at the bottom of a Linux screen, a Windows screen or any other operating system screen. To the user, it has the appearance of being a built-in part of the hardware, such as a separate LCD display might allow, without the cost of added hardware. It could be available to the user before and during the standard operating system boot process.

What is claimed is:

1. A computer comprising:
a processor;
a video controller having a video output;
a bus connected between the processor and the video controller; and
a communication device connected to the bus;
wherein an operating system, utilizing the processor, directs the operation of the video controller,
the computer further comprising a communications stack stored in the computer that communicates with a remote computer and with the video controller to control at least of a portion of the video output of the video controller, independent of the operation of the operating system.

2. The computer of claim 1 wherein the communications device comprises the communications stack, and wherein the communication device can be at least partially controlled by the operating system.

3. A method, using a computer comprising a processor; a video controller having a video output; a bus connected between the processor and the video controller; and a communication device connected to the bus; wherein an operating system, utilizing the processor, directs the operation of the video controller, the method comprising:
storing a communications stack in the computer, wherein the communications stack communicates with a remote computer and with the video controller to control at least of a portion of the video output of the video controller, independent of the operation of the operating system.
